(19) United States
(12) Patent Application Publication
(10) Pub. No.: US 2011/0313863 A1
(43) Pub. Date: Dec. 22, 2011

(54) Systems and Methods for Opportunity-Based Services

(76) Inventors: Gregory D. Carter, North Reading, MA (US); Lawrence J. O'Toole, IV, Walpole, MA (US); Joseph M. Steen, Lowell, MA (US)

(21) Appl. No.: 13/164,236

(22) Filed: Jun. 20, 2011

Related U.S. Application Data
(60) Provisional application No. 61/356,787, filed on Jun. 21, 2010.

(51) Int. Cl. G06Q 30/00; G06F 17/30

(52) U.S. Cl. 705/14.66; 705/14.49; 707/723; 707/E17.014

(57) ABSTRACT

Systems and methods for presenting a user with one or more forms of data, including, systems and methods of interactively searching and/or matching a user to an opportunity as well as obtaining a related score, and other information related thereto, preferably where the user has the ability to manage, utilize tools and receive education related thereto.

### PRIORITY/CROSS-REFERENCE TO RELATED APPLICATIONS

This application claims the benefit of U.S. Provisional Application No. 61/356,787, filed Jun. 21, 2010, the disclosure of which is hereby incorporated by reference into this disclosure in its entirety.

### TECHNICAL FIELD

The invention relates generally to providing one or more forms of data. More particularly, the invention relates to systems and methods of interactively searching opportunity-based data and providing a user with information and scores related thereto.

### BACKGROUND

Many resources are presently available to assist individuals and businesses in finding suitable opportunities pertaining to the areas of interest being researched. For example, in the field of job placement, direct advertising by employers in the employment section of a newspaper or magazine, internet job postings, and job board websites provide job seekers with the ability to research employment opportunities. In the example of job board websites, companies can share job opportunities and allow job seekers to review these opportunities. Unfortunately, however, some drawbacks associated with job board websites are the volume of opportunities, and the amount and type of information provided to a user. For example, job board websites do not allow a user to further research the opportunity he/she has been presented with to determine its compatibility with the user. Job board websites also do not provide feedback from an experienced community familiar with an opportunity or unique and pertinent education offerings associated with an opportunity.

### SUMMARY OF THE DISCLOSURE

The following presents a simplified summary of the invention in order to provide a basic understanding of some aspects of the invention. This summary is not an extensive overview of the invention. Its sole purpose is to present some concepts of the invention in a simplified form as a prelude to the more detailed description that is presented later.

Several exemplary systems and methods of interactively searching and presenting a user with opportunity-based data and providing scores related thereto are described.

Various systems and methods which enable a user to search one or more areas of personal and/or professional interest and be provided with a list of relevant opportunities, third party information, attributes related thereto, and/or a score affiliated with an opportunity which is calculated from aggregating scores affiliated with one or more opportunity attributes, and/or matching one or more user attributes and/or opportunity attributes and determining the compatibility of the opportunity with the user, are described herein. For example, various systems and methods which provide a user with a score that identifies an opportunity's viability, and/or compatibility with a user, or for an individual in general, are described.

In addition, various systems and methods which allow user to review attributes associated with an opportunity, conduct and track research associated with an opportunity, and provide a user with resources, services, tools, and educational courses related to opportunities and/or employment in general are described.

Additional understanding of the systems and methods contemplated and/or claimed by the inventor can be gained by reviewing the detailed description of exemplary systems and methods, presented below, and the referenced drawings.

### BRIEF DESCRIPTION OF THE DRAWINGS

FIG. 1 illustrates an exemplary computing system.

FIG. 2 illustrates an exemplary database.

FIG. 3 illustrates an exemplary opportunity and attributes.

FIG. 4 illustrates an exemplary user profile and attributes.

FIG. 5 illustrates a flowchart representation of an exemplary method of using opportunity-based searching and scoring.

FIG. 6 illustrates an exemplary screen shot of an exemplary graphic user interface (GUI).

FIG. 7 illustrates another exemplary screen shot of a second exemplary GUI.

FIG. 8 illustrates another exemplary screen shot of a third exemplary GUI.

FIG. 9 illustrates another exemplary screen shot of a fourth exemplary GUI.

FIG. 10 illustrates another exemplary screen shot of a fifth exemplary GUI.

FIG. 11 illustrates another exemplary screen shot of a sixth exemplary GUI.

FIG. 12 illustrates another exemplary screen shot of a seventh exemplary GUI.

FIG. 13 illustrates another exemplary screen shot of an eighth exemplary GUI.

FIG. 14 illustrates another exemplary screen shot of a ninth exemplary GUI.

FIG. 15 illustrates another exemplary screen shot of a tenth exemplary GUI.

FIG. 16 illustrates another exemplary screen shot of an eleventh exemplary GUI.

FIG. 17 illustrates another exemplary screen shot of a twelfth exemplary GUI.

FIG. 18 illustrates another exemplary screen shot of a thirteenth exemplary GUI.

FIG. 19 illustrates another exemplary screen shot of a fourteenth exemplary GUI.

FIG. 20 illustrates another exemplary screen shot of a fifteenth exemplary GUI.

FIG. 21 illustrates another exemplary screen shot of a sixteenth exemplary GUI.

FIG. 22 illustrates another exemplary screen shot of a seventeenth exemplary GUI.

FIG. 23 illustrates another exemplary screen shot of an eighteenth exemplary GUI.

FIG. 24 illustrates another exemplary screen shot of a nineteenth exemplary GUI.

FIG. 25 illustrates another exemplary screen shot of a twentieth exemplary GUI.

FIG. 26 illustrates another exemplary screen shot of a twenty-first exemplary GUI.

FIG. 27 illustrates another exemplary screen shot of a twenty-second exemplary GUI.

FIG. 28 illustrates another exemplary screen shot of a twenty-third exemplary GUI.

FIG. 29 illustrates another exemplary screen shot of a twenty-fourth exemplary GUI.

### DETAILED DESCRIPTION

The following detailed description and the referenced drawings provide illustrative examples of that which the inventors regard as their invention. As such the embodiments discussed herein are merely exemplary in nature and are not intended to limit the scope of the invention, or its protection, in any manner. Rather, the description and illustration of these embodiments serve to enable a person of ordinary skill in the relevant art to practice the invention.

The use of “e.g.,” “etc,” “for instance,” “in example,” and “or” and grammatically related terms indicates non-exclusive alternatives without limitation, unless otherwise noted. The use of “including” and grammatically related terms means “including, but not limited to,” unless otherwise noted. The use of the articles “a,” “an” and “the” are meant to be interpreted as referring to the singular as well as the plural, unless the context clearly dictates otherwise. Thus, for example, reference to “an attribute” includes two or more such attributes, and the like. The use of “exemplary” means “an example of” and is not intended to convey a meaning of an ideal or preferred embodiment.

As used herein, the term “opportunity” refers to one or more opportunities, results, job opportunities, real estate opportunities, work from home opportunities, employment opportunities, home-based businesses opportunities, higher education opportunities, and/or business opportunities, unless the context clearly dictates otherwise. The term “attribute” refers to data, information, facts, figures, statistics, and/or material, unless the context clearly dictates otherwise.

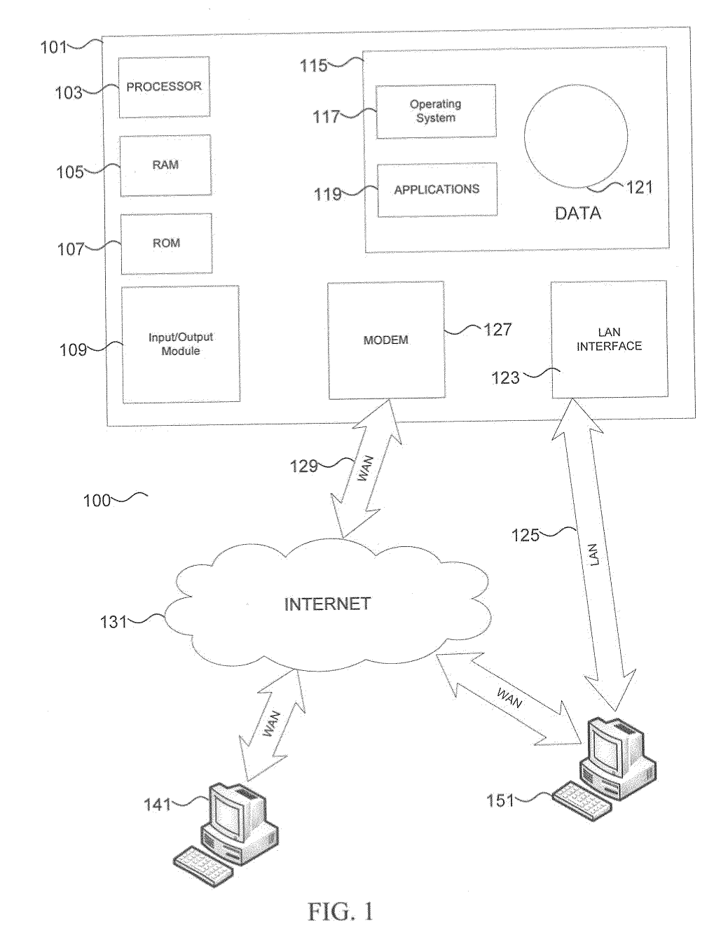

The systems and methods described herein which provide opportunity-based searching, matching, scoring, management, education, tools and additional resources and services are embodied in a computing system environment. FIG. 1 illustrates an exemplary computing system environment, represented generally at 100. The computing system environment 100 is only one example of a suitable computing environment and skilled artisans will be able to select an appropriate computing environment according to a particular embodiment based on various considerations, including the intended use of the systems and methods described herein.

The systems and methods described herein are operational with numerous other general purpose or special purpose computing system environments or configurations. Examples of computing systems, environments, and/or configurations that are considered suitable for use with the herein described systems and methods include, but are not limited to, personal computers, smart phones, server computers, hand-held or laptop devices, multiprocessor systems, microprocessor-based systems, set top boxes, programmable consumer electronics, network PCs, minicomputers, kiosks, mainframe computers, netbooks, tablets, and/or distributed computing environments that include any of the above systems, devices, or the like.

The systems and methods described herein can be described in the general context of computer executable instructions, such as program modules, or program components, being executed by a computer. Program modules or components include routines, programs, objects, components, data structures, etc. that perform particular tasks or implement particular abstract data types. The systems and methods described herein can also be practiced in distributed computing environments where tasks are performed by remote processing devices that are linked through a communications network. In a distributed computing environment, program modules or components can be located in both local and remote computer storage media including memory storage devices.

With reference to FIG. 1, the computing system environment 100 can include a computer 101 having a processor 103 for controlling overall operation of the computer 101 and its associated components, including RAM 105, ROM 107, an input/output module or BIOS 109, and a memory 115. The computer 101 typically includes a variety of computer readable media. The computer readable media can be any available media that can be accessed by the computer 101 and can include both volatile and nonvolatile media and removable and non-removable media. By way of example, and not limitation, computer readable media can comprise computer storage media and communication media.

Computer storage media can include volatile, nonvolatile, removable, and non-removable media implemented in any method or technology for storage of information such as computer readable instructions, data structures, program modules, or other data. Computer storage media includes, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, and any other medium that can be used to store the desired information and that can be accessed by the computer 101.

Communication media can embody computer readable instructions, data structures, program modules, program components, and/or other data in a modulated data signal such as a carrier wave or other transport mechanism. It can also include any information delivery media. A modulated data signal is a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media. Although not shown, RAM 105 can include one or more applications representing the application data stored in RAM 105 while the computer is on and corresponding software applications (e.g., software tasks) are being executed.

The input/output module or BIOS 109 can include a microphone, keypad, touch screen, and/or stylus through which a user of the computer 101 can provide input. The input/output module or BIOS 109 can also include one or more of a speaker for providing audio output and a video display device for providing textual, audiovisual, and/or graphical output.

Software can be stored within memory 115 to provide instructions to the processor 103 for enabling the computer 101 to perform various functions. For example, the memory 115 can store software used by the computer 101, such as an operating system 117, applications 119, and an associated data file 121. Alternatively, some or all of the computer executable instructions for the computer 101 can be embodied in hardware or firmware (not shown). As described in detail below, the data file 121 can provide centralized storage of data.

The computer 101 can operate in a networked environment that supports connections to one or more remote computers, such as computing devices 141 and 151. The computing devices 141 and 151 can be personal computers or servers that include many or all of the elements described above relative to the computer 101. The network connections depicted in FIG. 1 can include a local area network (LAN) 125 and a wide area network (WAN) 129 and can also include other networks. The computer 101 is connected to the LAN 125 through a network interface or adapter 123. The computer 101 can be a server and can include a modem 127 or other means for establishing communications over the WAN 129. For example, the computer 101 can connect to a WAN 129 such as the Internet 131 through a modem connection. The network connections can include any communications link between computers.

The existence of any of various well-known protocols such as TCP/IP, Ethernet, FTP, HTTP, and the like is presumed, and the system can be operated in a client-server configuration to permit a user to retrieve web pages from a web-based server. Any of various conventional web browsers can be used to display and manipulate data on web pages.

An application program can be used by the computer 101 to perform and/or execute one or more elements of the systems and methods described herein. The application program can include computer executable instructions for invoking user functionality related to communication, such as email, short message service (SMS), and voice input and speech recognition applications.

The computing devices 101, 141 or 151 can also be mobile terminals including various other components, such as a battery, speaker, and antennas (not shown). The input/output module or BIOS 109 can include a user interface including such physical components as a voice interface, one or more arrow keys, joystick, data glove, mouse, roller ball, touch screen, or the like.

Each of the plurality of computing devices 101, 141, 151 can contain software for creating a data file 121. The software can be a set of detailed computer-executable instructions for the computing devices 101, 141, 151. The software can provide the computing devices 101, 141, 151 with the ability to create a data file 121. The data file 121 can contain multiple individual files of information. For example, a plurality of inventory or attributes can be managed and information relating to each inventory or attribute can be received onto a computer network. The information relating to each inventory or attribute can be separately contained in a unique data file 121. One or more of the data files relating to a plurality of inventories or attributes can be coupled to each other in any suitable fashion.

The computer 101 can include memory 115 for storing computer-readable instructions and a processor 103 for executing the computer-executable instructions. The computer-executable instructions can be data in the form of program source code that can be capable of modifying the data file 121. The computer-executable instructions can be a series or sequence of instructions for a computing device that is typically in the form of a programming language such as C++, Java, SQL, or the like. Various computer-programming languages can be used to create the computer-executable instructions, and the systems and methods described herein are not limited to the programming languages listed above.

The memory 115 can be a portion of the computer 101 that stores data or other instructions. The memory 115 can be retained or lost when power is lost to the system. The memory 115 can provide access to data for a user or computing device 101, 141, 151 to revise and manage a data file 121.

The processor 103 can be capable of executing the computer-executable instructions. The processor 103 can execute the computer-executable instructions after they have been stored in the memory 115. The processor 103 can be a centralized element within a computing system that is capable of performing computations. For example, the processor 103 can perform the computations that are described in the computer-executable instructions and then execute the computer-executable instructions. The computer-executable instructions can include data describing changes to the data file 121 that were made by a user or computing device 101, 141, 151 over a computer network such as the Internet 131, or intranet (not shown). The computer 101 stores the data in the data file 121. The data file 121 can be stored in the memory 115 so that it can be accessible to a plurality of computing devices 141, 151 and/or users.

Data relating to the systems and methods described herein can be stored in data file 121. Security precautions can be implemented to prevent unauthorized access to the data file 121. For example, user identification and/or a password can be required to access the data file 121 and/or the data relating to the systems and methods described herein. Some of the data that is stored in the data file 121 can be shared between multiple data files. Any desirable security precautions can be implemented.

The computer-executable instructions can be a series or sequence of instructions for a computing device 101, 141, 151, as described in detail throughout this disclosure. The processor 103 can be configured to execute the computer-executable instructions and can be used to provide an opportunity-based search, match, management, score, educational information, and tools in accordance with one or more of the systems and methods described herein. Such computer-executable instructions can be located (e.g., physically, logically) in modules or components in the memory 115. The computer network 131 can be any network that interconnects users and/or computing devices 101, 141, 151. For example, the computer network 131 can provide shared access by two computing devices to at least a portion of the data in the plurality of modules or components. Shared access can be provided between two or more computing devices 101, 141, 151 that are coupled to the computer network 131 and/or that are able to communicate with each other and/or access, change, and add data to a data file 121.

A computer network such as the Internet 131 provides access to the data file 121 that can be shared between the computing devices 101, 141, 151.

Additionally, the computer network can be public or private and can be wired or wireless. The computing devices 101, 141, 151 that are coupled to the computer network can be any electronic device that is capable of connecting to a computer network and transmitting or receiving data over the computer network. Furthermore, the computing devices are capable of receiving data for entry into a data file 121 which can be associated with one or more of the elements associated with systems and methods described herein. The systems and methods described herein can be utilized through a computer-readable medium, a web site, an application, a server, or any other means of providing an opportunity-based search, match, management, score, educational information, resources, and tools.

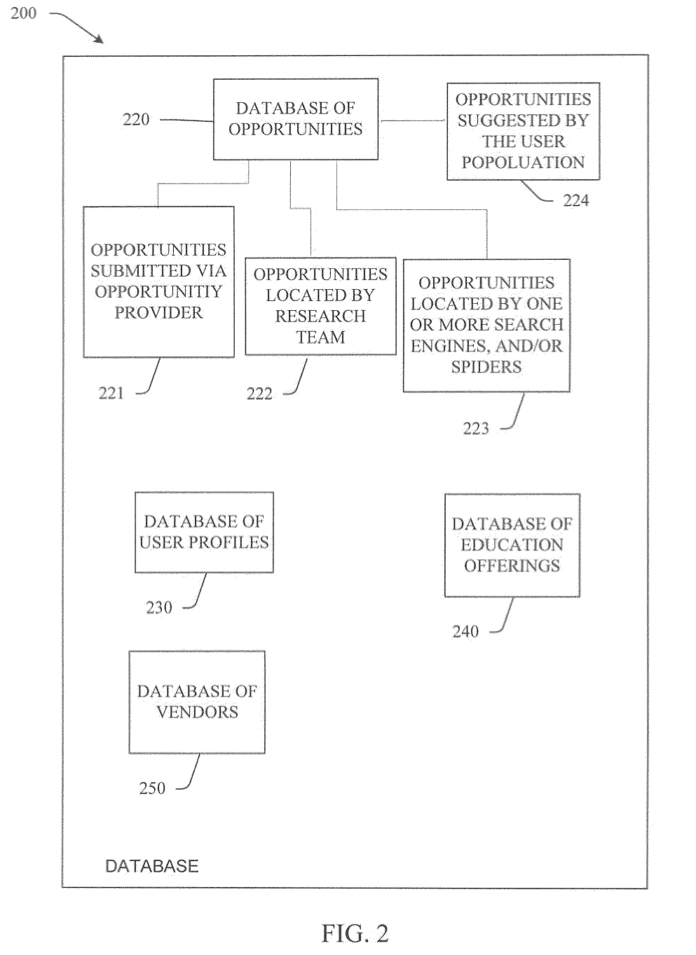

FIG. 2 illustrates an exemplary database, represented generally at 200. The database 200 is a stored component, which can be executed and/or accessed by a CPU. The database 200 comprises a database of one or more opportunities 220, a database of one or more user profiles 230, a database of education offerings 240, and a database of vendors 250 (e.g., third party products, services), among other data. The database of opportunities 220 can be populated by one or more opportunities submitted via an opportunity provider 221, opportunities located by a research team 222 (e.g., internal, external), opportunities located by one or more search engines, screen scrapers, and/or spiders 223, and/or opportunities suggested by the user population 224. Data and attributes within database 200 can be collected and compiled via at least one or more automated systems, programs, applications, modules, and/or other means and methods as described herein. Examples of attributes stored in database 200 can include, but are not limited to, any of the attributes described herein.

The database of educational offerings 240 can comprise any form of educational material that is associated with an opportunity. Examples of suitable education materials include, but are not limited to, books, articles, websites, videos, seminars, audio, and the like.

The database of vendors 250 can comprise any form of vendor material that is provided by a vendor. Examples of suitable vendor materials include, but are not limited to, advertisements, vendor information, sales information, banners, links, redirects, user attributes, opportunity attributes, and/or the like.

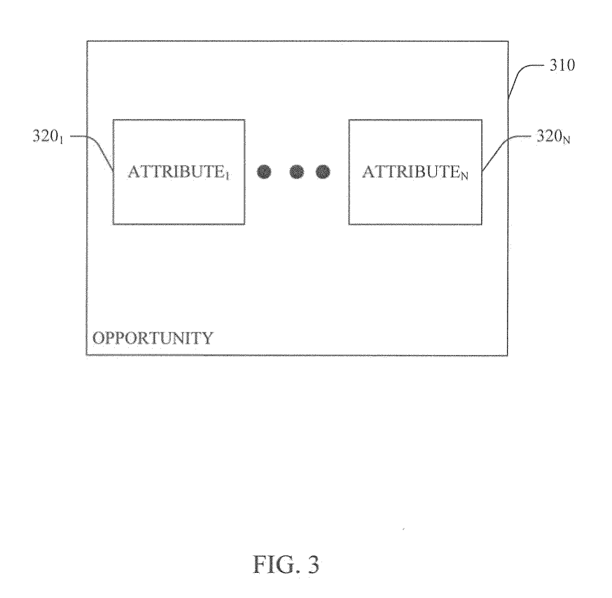

FIG. 3 illustrates an exemplary opportunity, represented generally at 310, and the attributes 320_{1-N} associated thereto. Said opportunity 310 and attributes 320_{1-N} can be stored in database 200 and within database of opportunities 220. The one or more opportunity attributes 320_{1-N} can comprise a company name, company website, company revenue, number of company employees, company start date, company contact information, company location, internal user company community rating, credibility indicators extracted from third party sources, competitor information, trust rating, trustworthiness, vender reliability, user feedback, Amazon rating, Better Business Bureau Grading, privacy, web rank, social media feedback score, web traffic/trend analysis, company financials, third party financial analysis, demographic profiling, age, income, gender, defined manual research, internal analysis points, external analysis points, user defined manual research, vendor relationships, and/or website administrator notes. In an example, the opportunity attributes can be provided to a user within a details tab within a website, wherein attributes associated with a business overview or premium opportunity details can also be provided. In an additional example, the opportunity attributes can be provided to a user within an opportunity tab on a web site. Additional attributes are intended to be included within an opportunity's data structure, as described herein.

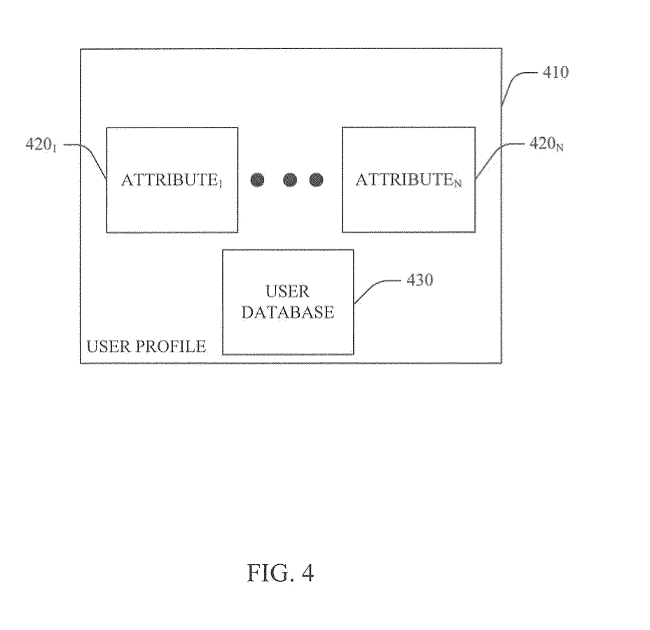

FIG. 4 illustrates an exemplary user profile, represented generally at 410, and the attributes associated 420_{1-N} thereto. User profile 410 and attributes 420_{1-N} can be stored in database 200 and within the database of user profiles 230. The one or more user attributes 420_{1-N} can comprise the user's location, age, work experience, demographics, skill sets, current employment status, email, phone number, username, password, billing address, gender, how much the user is willing to spend to start work from home opportunity, how many hours per week the user will be devoting to the home-based business, how many hours the user is willing to work for an employer at home, educational background, household income, where the household income comes from, marital status, race, dependents, and/or desired opportunity attributes (e.g., would the user like to be self employed (examples of user attributes gathered if user would like to be self employed—the reasons the user would like to work from home, background information, what business method the user would utilize, what categories of business service or product the user is interested in providing, internet access, would the user like to recruit business partners, manage other people, minimum number of years company has to have been in business, and/or current employer type) or an employee (examples of user attributes gathered if user would like to be employee—has the user ever worked as employee out of own home, experience in sales or marketing, incentives for wanting to work from home), or both). One or more of the listed user attributes 420_{1-N} described herein can be gathered via questionnaire requesting information relating to a user who is interested in an opportunity. User profiles 410 can maintain a user database 430, which can store a user's search results, educational research, the results of user research on one or more opportunities, and/or any other information (e.g., attributes), as described herein. Additional attributes are intended to be included within a user profile data structure, as described herein.

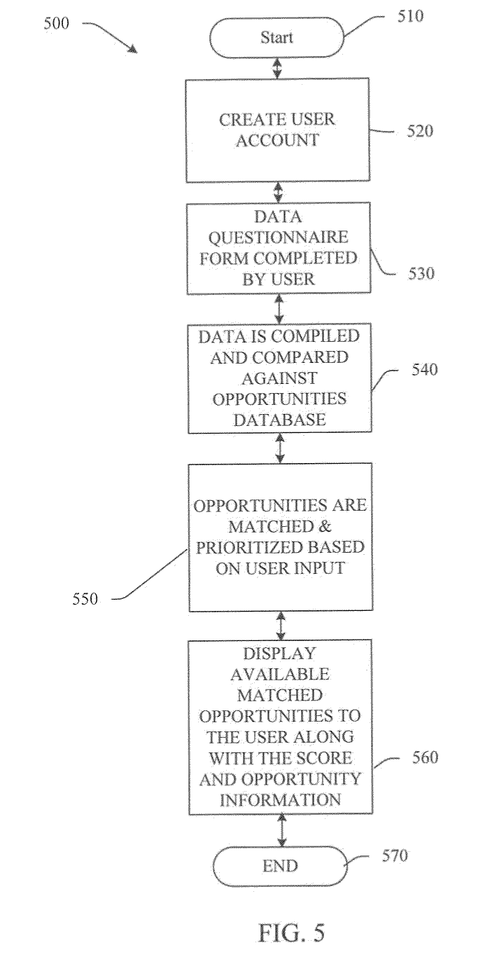

With reference to FIG. 5, a flow chart is illustrated to facilitate clarity and understanding of at least one exemplary method providing an opportunity-based service. While, for purposes of simplicity of explanation, the methodology shown herein, for example, in the form of a flow chart, is shown and described as a series of acts, it is to be understood and appreciated that the systems and methods described herein are not limited by the order of acts, as some acts can, in accordance with the systems and methods described herein, occur in a different order and/or concurrently with other acts other than those shown and described. For example, those skilled in the art will understand and appreciate that a methodology could alternatively be represented as a series of interrelated states or events. Moreover, not all illustrated acts, or in the alternative additional acts, may be required to implement a methodology in accordance with various systems and methods described herein. The flowchart representation illustrated in FIG. 5 is not meant to limit the scope of the systems and methods described herein to the scenario and interactions described, but rather to highlight particular interactions and to aid understanding.

FIG. 5 illustrates a flow chart representation of an exemplary method of using opportunity-based searching and scoring, represented generally at 500, via the Internet. It is to be understood, however, that the systems and methods disclosed herein can be utilized on one or more varying devices and/or platforms, or in one or more manners, as described herein (e.g., with respect to the various computing environments). The method begins at START block 510 and continues to block 520 where an individual seeking an opportunity using a client computer creates a user account on a website provided by a server computer. Creating a user account can be accomplished by one or more means. For example, a user can create a login and password, or be supplied with a one-time, or multiple-use, username and/or password. The creation of a user account can be an optional requirement for a user to access the system (e.g., web site) and the information contained therein. For example, a user can search the opportunities and be provided with a list of opportunities without creating a user account. In a further example, the user can accomplish one or more of the listed steps and or functionalities described herein with or without creating a user account. An administrator can manipulate the amount and type of information provided to a user and/or by the type of membership the user holds.

The method continues to block 530 at which point a user completes one or more data questionnaire forms. The one or more data forms seek information relating to the user (e.g., user attributes). This information is stored as user attributes 420_{1-N} and associated with the user profile 410 in the user database 430 and/or the database of user profiles 230. At 540 the data is compiled and compared against opportunities 310, opportunity attributes 320, and the database of opportunities 220. At 550 the database of opportunities 220, opportunity attributes 320, and opportunities 310 are filtered and matched with the user 410 and prioritized based on the compiled user attributes 420_{1-N}. A score is associated with an opportunity, user, or combination thereof and is formulated utilizing one or more opportunity attributes 320_{1-N}, user attributes 420_{1-N}, user profiles 410, and/or how the one or more opportunity attributes 320_{1-N} relate to the one or more user attributes, in addition to other attributes and data as described herein. For example, opportunities are filtered and scored based on the percentage, type, and/or amount of matching data points between the user attributes 420_{1-N}, opportunity attributes 320_{1-N}, or a combination thereof.

The matching data points can be based on the user's answers to the questions provided in the questionnaire. For example, a user can be asked to provide acceptable parameters for the opportunity attributes 320_{1-N} (e.g., location of opportunity, and/or any other opportunity attribute described herein). These acceptable parameters can be saved as user attributes 420_{1-N}. If the user's provided parameters (e.g., user attributes 420_{1-N}) match the supplied opportunity attributes 320_{1-N} a matching data point (e.g., correlating data point) exists.

In another example, which can be used separately from, or in conjunction with the above user parameter example, the matching data points can be based on the opportunity's answers to questions provided in a questionnaire. For example, an administrator of an opportunity can be asked to provide acceptable parameters for the user attributes 420_{1-N} (e.g., location of user, and/or any other user attribute described herein, or the like). These acceptable parameters can be saved as opportunity attributes 320_{1-N}. If the opportunity's provided parameters (e.g., opportunity attributes 320_{1-N}) match the supplied user attributes 420_{1-N} a matching data point (e.g., correlating data point) exists.

At 560 the results of the matching and the scores associated thereto are presented to a user. At which point a user can continue to research each individual result, or groups thereof, and the attributes associated thereto (e.g., opportunity attributes). For example, a user may view and research one or more of the opportunity results, the scores associated thereto, and/or the one or more opportunity attributes as described herein. In another example, a user can conduct additional research, education, leverage 3^{rd} party resources, search additional services and/or utilize tools to benefit understanding of an opportunity, among other things, and maintain this information and/or the results of such research in the user database 430 which can be stored on the server computer or locally on a client computer. In a further example, a user can conduct online learning, peer to peer communication, speak with live counselors, review online resources, be provided with training material, be provided with 3^{rd} party marketing material associated with at least one or more of the attributes described herein, and/or be updated on new areas of interest via email, push type technology, or the like. Educational information, such as courses, lectures, and personal assistance can be provided to a user to assist him or her in succeeding with an opportunity. User access to specific information, attributes, and other data can be restricted based upon a user's subscription status to the service, or otherwise. In an even further example, the opportunity results can be provided to a user in a manner that allows the user to compare one or more opportunities side by side with opportunity attributes 320_{1-N} listed for each opportunity, compare the opportunity attributes 320_{1-N} to the user attributes 420_{1-N}, and/or a comparison of the matched user attributes 420_{1-N} and the opportunity attributes 320_{1-N}.

Providing a user with relevant opportunities that fit their individual needs and scoring these opportunities allows for improved effectiveness in opportunity-based searching and potentially increases the satisfaction level of the user. In addition, associating a score with an opportunity provides a user with an indication as to an opportunity's dependability and compatibility with the user. Furthermore, scoring an opportunity assists the user in determining if an opportunity will provide the functionality the user is seeking.

Another exemplary method of determining the score associated with an opportunity comprises compiling one or more opportunities attributes, scoring one or more of the opportunity attributes, and aggregating the score and presenting a percentage to a user. For example, one or more opportunity attributes (e.g., trustworthiness, vendor reliability, privacy rating, sentiment analysis, trust rating, traffic profile, trust gauge score, company start date, affiliated seals) can be associated with a score, which is based on a scale of point values associated with the one or more opportunity attributes. The scale is based on a point range which has a high potential point value, a low potential point value, and intermediate point values between the high and low point value. The point value associated with the one or more opportunity attributes can be aggregated and associated/affiliated with an opportunity, which is associated with an aggregated score. For example, the one or more attributes (e.g., trustworthiness, vendor reliability, privacy) can be associated with a point value based on the reputation and/or confidence of the opportunity. The point value associated with one or more of these attributes can be a point value which varies based on the level of the opportunity attributes reputation and/or confidence. For example, the point value can increase as the reputation and/or confidence of the opportunity increases, and decrease as the reputation and/or confidence of the opportunity decreases. After a point value has been associated with one or more opportunity attributes, the points can be aggregated and a percentage can be calculated and presented to the user. The percentage is calculated based on the actual aggregated point value associated with an opportunity and the highest potential score that could be associated with that opportunity (e.g., actual divided by potential).

For example, the score associated with an opportunity can have a potential total weighted value of 100 points, which is based on one or more opportunity attributes considered having the highest point value. If an opportunity attribute does not fall within the highest point value for that attribute (e.g., a range encompassing the highest rating score for that attribute) a lower point value is associated with the attribute and the overall score associated with an opportunity is lowered, thereby lowering the percentage presented to a user. The point value associated with the one or more opportunity attributes can vary depending on the level the attribute falls within on the scale associated with the one or more attributes. Once a point value is associated with an opportunity, that point level can be presented to a user, and/or computed as a percentage based on the total potential points associated with one or more opportunity attributes and the actual points associated with the one or more opportunity attributes, and presented to a user.

In accordance with the systems and methods described herein, a user can also leverage services as well as third party products and services, wherein the user is provided with products, services, and/or educational services, which can relate to a specific opportunity and/or user based on the opportunity attributes 320_{1-N} and/or user attributes 4201-N, or be general in nature. For example, a user is able to select a product like a book, video, seminar, etc. to deepen their understanding of a given topic. Services such as remote data backup, remote accounting, home office supplies, etc. can be selected to equip a user with an opportunity. In addition, a user can be provided with structured courses to assist in broadening their education on a given topic. Furthermore, a user can receive proactive notifications if a new opportunity is added to the database or track preexisting opportunities through at least one of the following: a website, text, email, mobile application, application, and/or the like.

User functionality can provide various alternative resources to a user and allows a user to associate one or more attributes with an opportunity. For example, users can submit feedback relating to an opportunity which can be stored as an opportunity attribute 320 within database 310 and/or 200, and/or users can provide personal ratings associated with an opportunity which can be associated as an opportunity attribute 320 within database 310 and/or 200. In another example, users can maintain research within a file designated to a particular opportunity. Said feedback and related research conducted by a user can be disclosed to other users or incorporated within the database 200 (e.g., user database 430). Demographics and other user attributes can be utilized to provide a user with information relating to an opportunity (e.g., user A, with associated user attributes (e.g., user attributes described herein), likes, or was associated with opportunity_{g}, based on user B having associated user attributes_{x′-y′}, which are similar to user A, B can be associated and provided with opportunity_{g}, or other like opportunities).

Users can utilize a chat, forum, blog, and email, which can be stored in database 121, and/or database 220 to leverage opportunity success. User feedback and/or ratings relating to an opportunity can be aggregated within the score associated with an opportunity. For example, when an online, or other type, of scam pattern or other fraudulent activity, is identified a user, or third party contributor, can submit this data and the systems and methods described herein can save the data to the opportunity database 310 and/or 200 as an opportunity attribute 320_{1-N}. Alternatively, this data can be obtained autonomously, or otherwise, as described herein. Any of the opportunity attributes, including those affiliated with scams and fraudulent activity, can be provided to users as requested (e.g., via website), in real-time, and/or as an update sent via email, as otherwise described herein, and/or the like. Attributes described herein can be refreshed and updated on a regular basis to provide real time data to a user. Furthermore, users can manually research predefined websites and list additional websites as well as the research results.

The score associated with each opportunity, user, and/or combination thereof, is based on a comparison of like elements between one or more opportunity attributes 320_{1-N}, user attributes 420_{1-N}, a combination thereof, or other attributes as described herein. The comparison determines if one or more matching data points exist between the one or more opportunity attributes 320_{1-N}, user attributes 420_{1-N}, and/or combination thereof. The score, one or more opportunity attributes 320_{1-N}, user attributes 420_{1-N}, and/or combination thereof can be displayed to the user via GUI, or the like. For example, among other various implementations, the systems and methods described herein can be accomplished in terms of a computer-implemented system comprising computer-executable components and/or a computer-implemented method comprising computer-executable acts.

In the example of a user seeking a work from home opportunity, the opportunity's attributes 320_{1-N} can include, among those described herein, one or more of an opportunity's prior success, failure, current success, current failure, the number of individuals who have attempted the opportunity, the number of complaints relating to the opportunity and/or the opportunity's affiliates, the opportunity's pay, and/or the financial performance of the opportunity. Furthermore, in an aspect, the one or more opportunity attributes 320_{1-N} associated with each opportunity can include, among those described herein, an opportunity's associated web page, web performance, domain information, location, domain disputes, and/or the criminal and civil records associated thereto. These opportunity attributes 320_{1-N} can be provided by one or more third party vendors, internal investigation, external investigation, spiders, crawlers, etc. and can be stored in database 121, database 200, opportunity database 310, and/or the database of vendors 250.

Alternatively, the score is based on an aggregated point value associated with one or more opportunity attributes. For example, the opportunity attributes considered in compiling the score can be weighted out of 100 points, where each of the considered opportunity attributes is associated with a score based on the attributes reliability, trustworthiness, and/or success, among other elements described herein.

In an example, the systems and methods described herein can be utilized to facilitate job placement (e.g., work from home opportunities) for a user. It is to be understood, however, that the systems and methods described herein are applicable to multiple environments and areas of interest for both individuals and businesses. The disclosed systems and methods allow users to search and review work from home opportunities, be matched to the most relevant opportunities available based on a correlation between users' attributes 420_{1-N} and opportunity attributes 320_{1-N}. The systems and methods also allow a user to review third party information related to opportunity attributes, or an opportunity in general, and be provided with a score that indicates each opportunity's compatibility as an option for that user, or other users in general.

While FIG. 5 has illustrated an exemplary method of opportunity-based searching and scoring, a user can utilize various alternative systems and methods to access opportunity-based services. For example, a user can search the database of opportunities and/or opportunity attributes with or without restricted access. In another example, a user can create an account with limited access and increase the user's access upon the fulfillment of membership obligations (e.g., agreeing to terms of services, payment of membership fee). In a further example, any of the various attributes can be provided to a user upon a user request and/or search. The various attributes can be restricted based on user membership status and/or opportunity status.

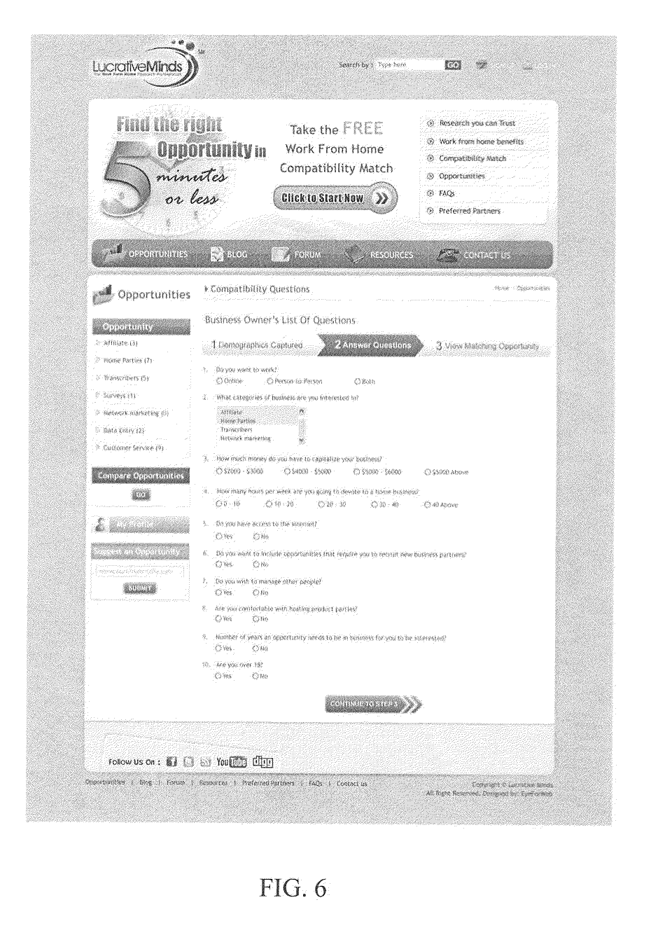

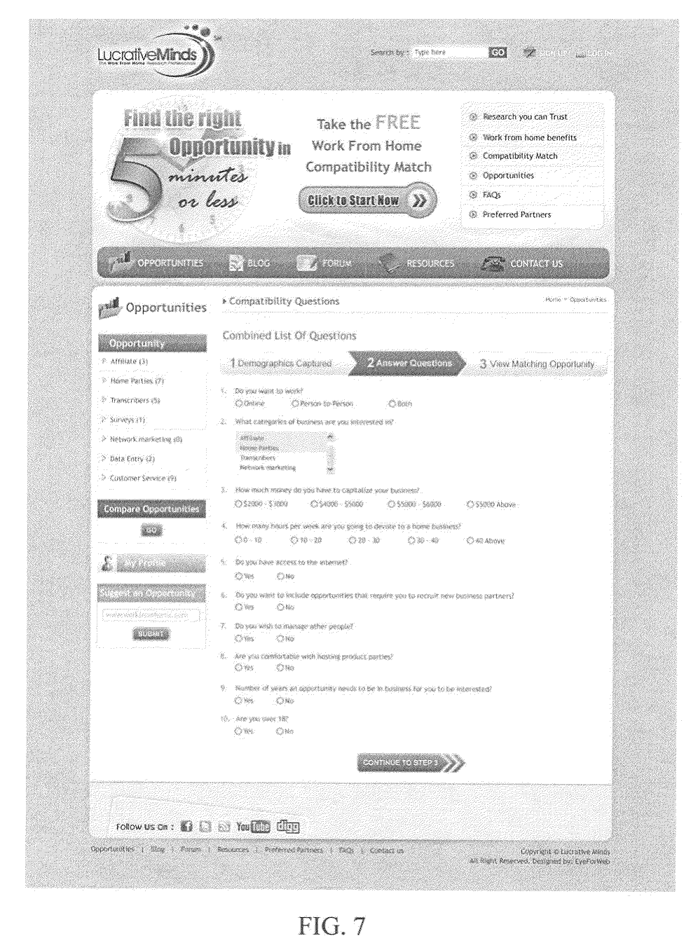

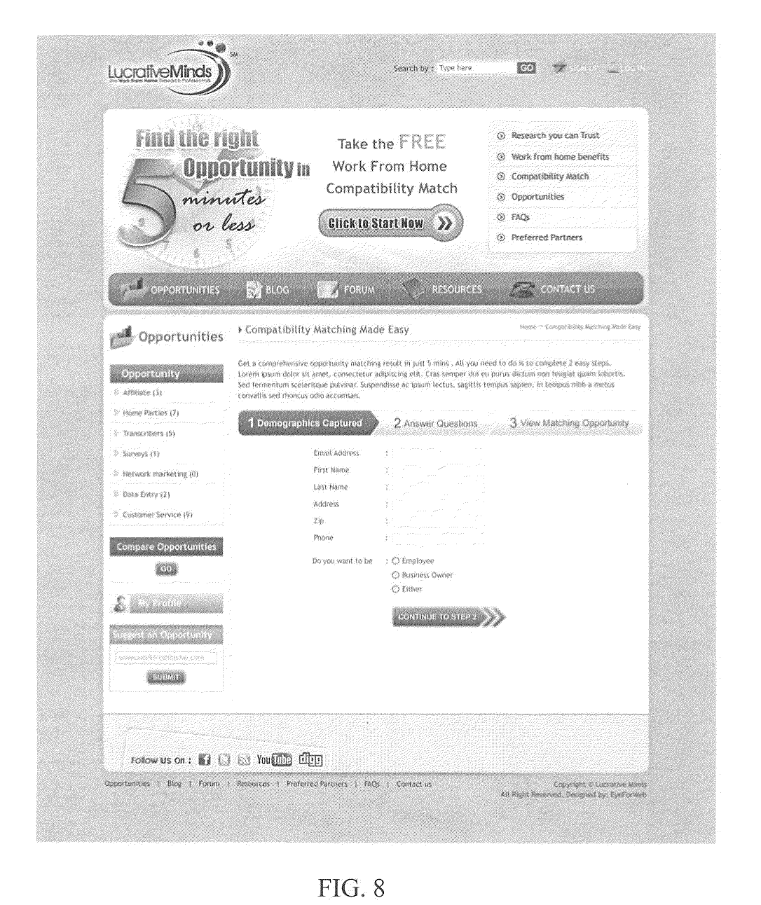

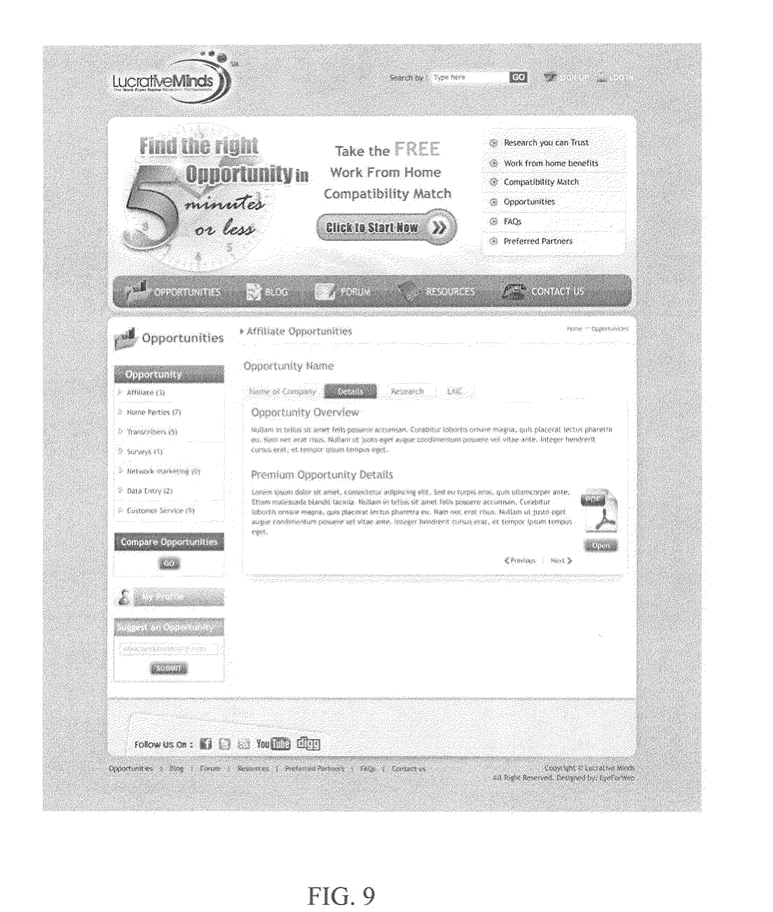

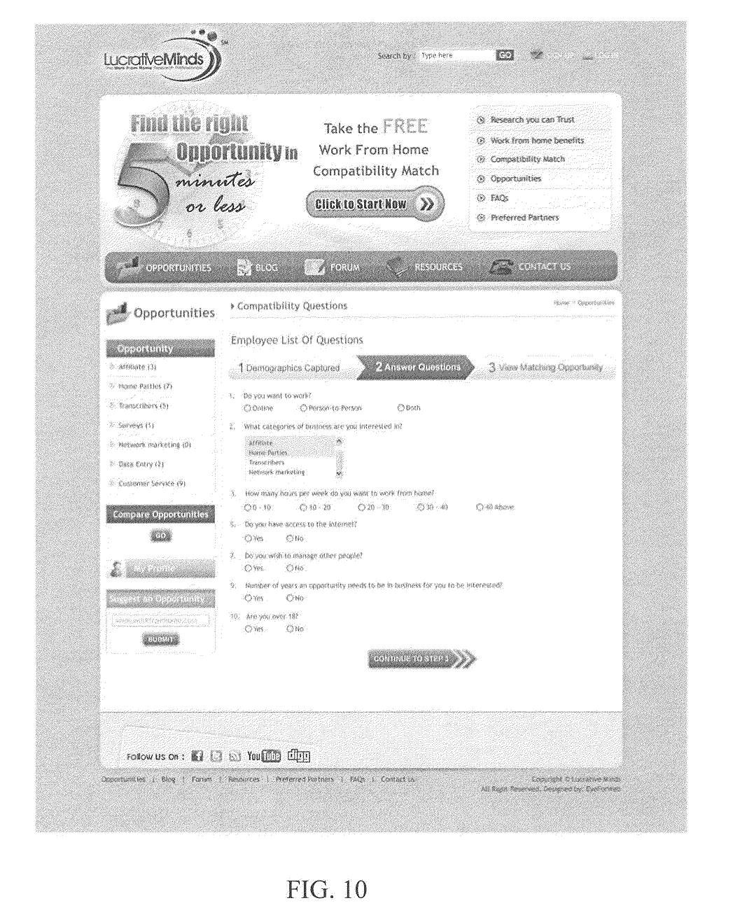

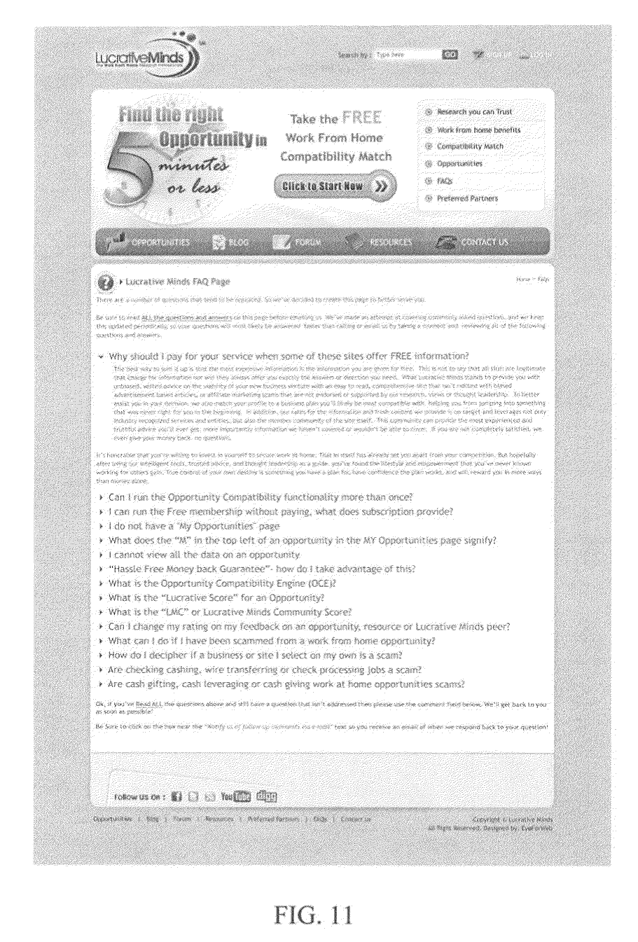

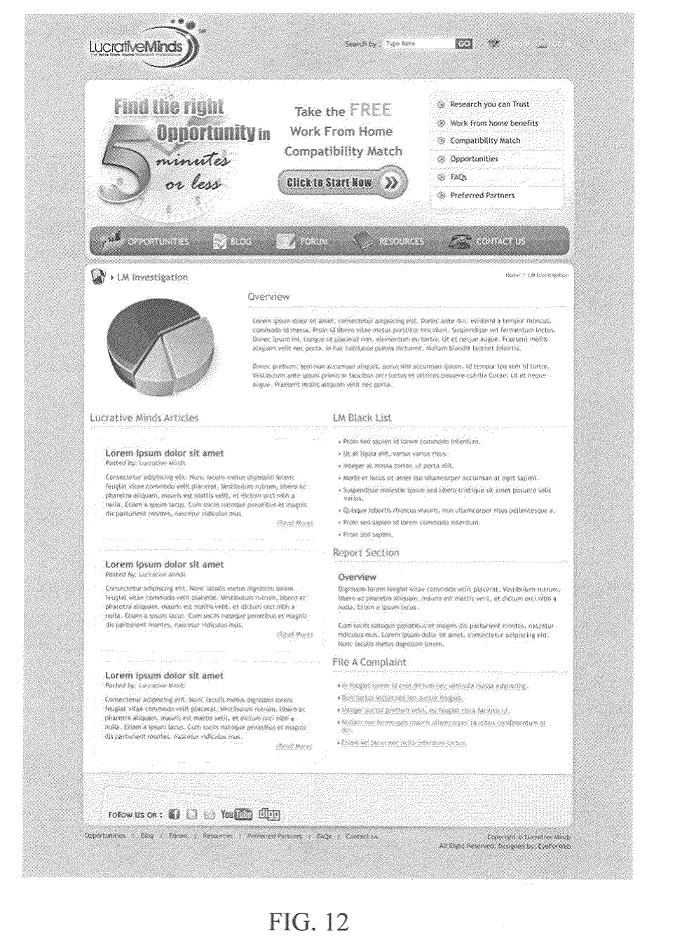

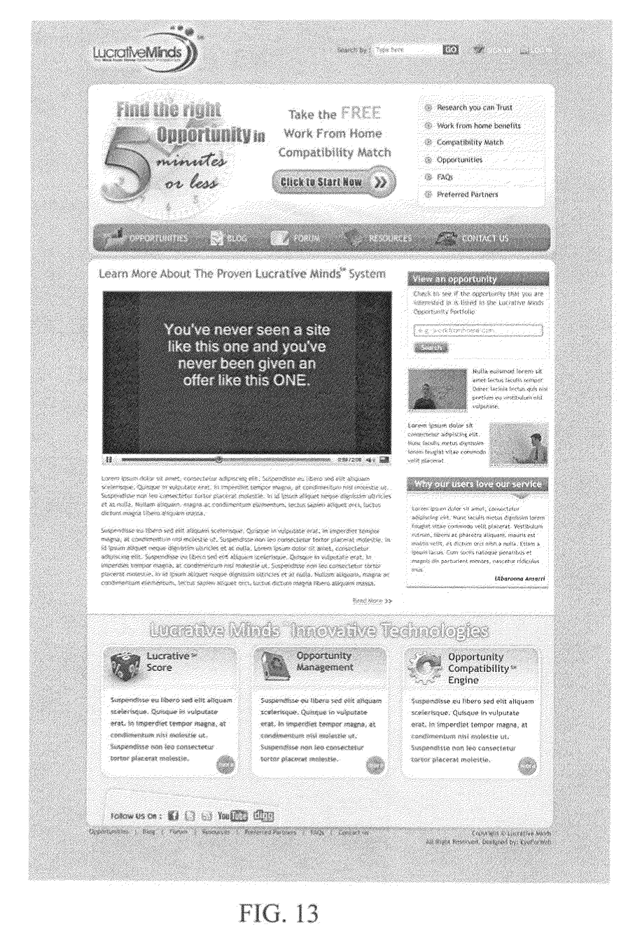

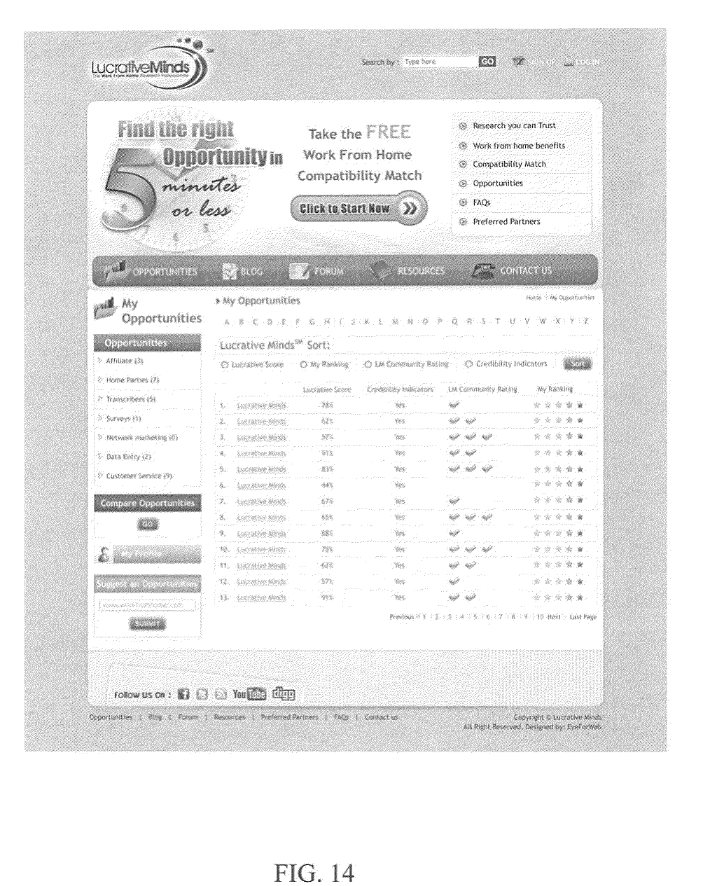

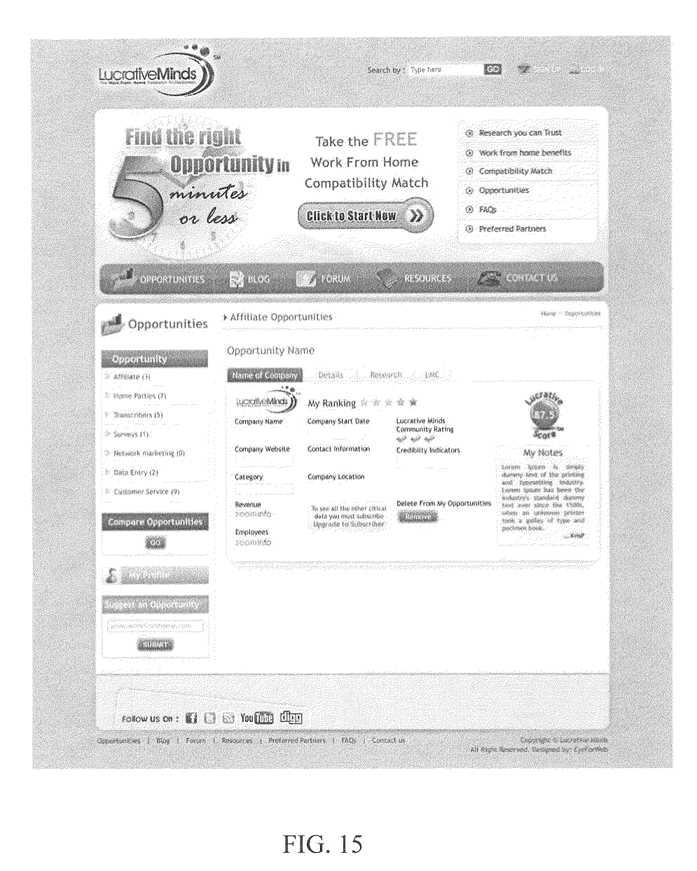

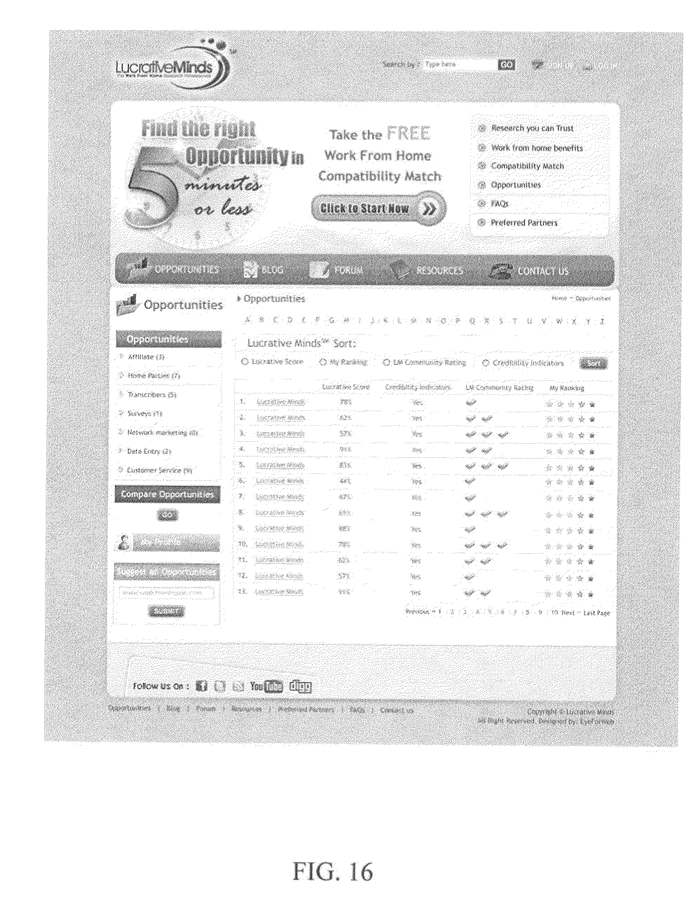

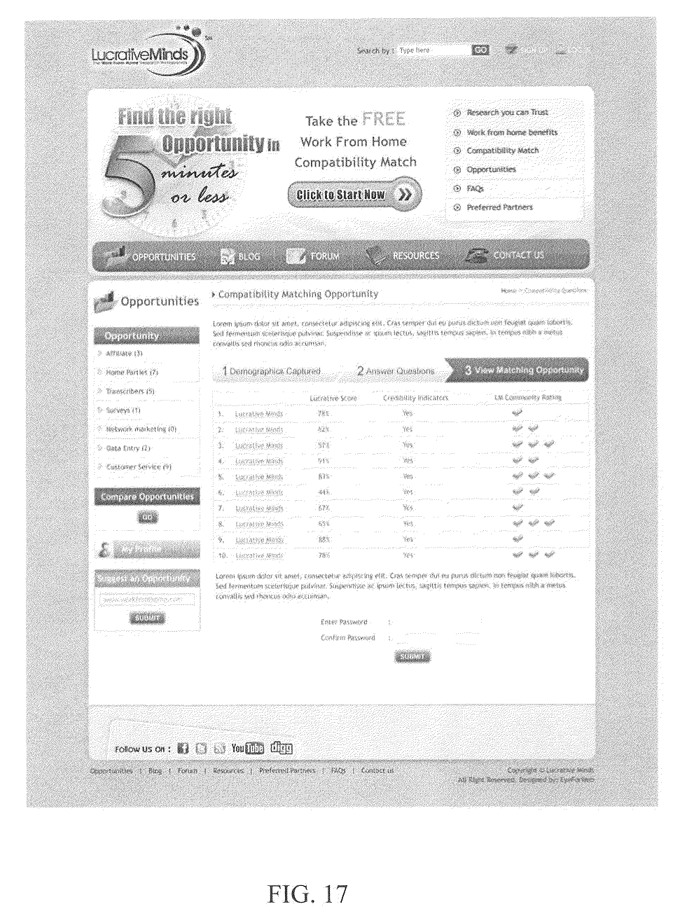

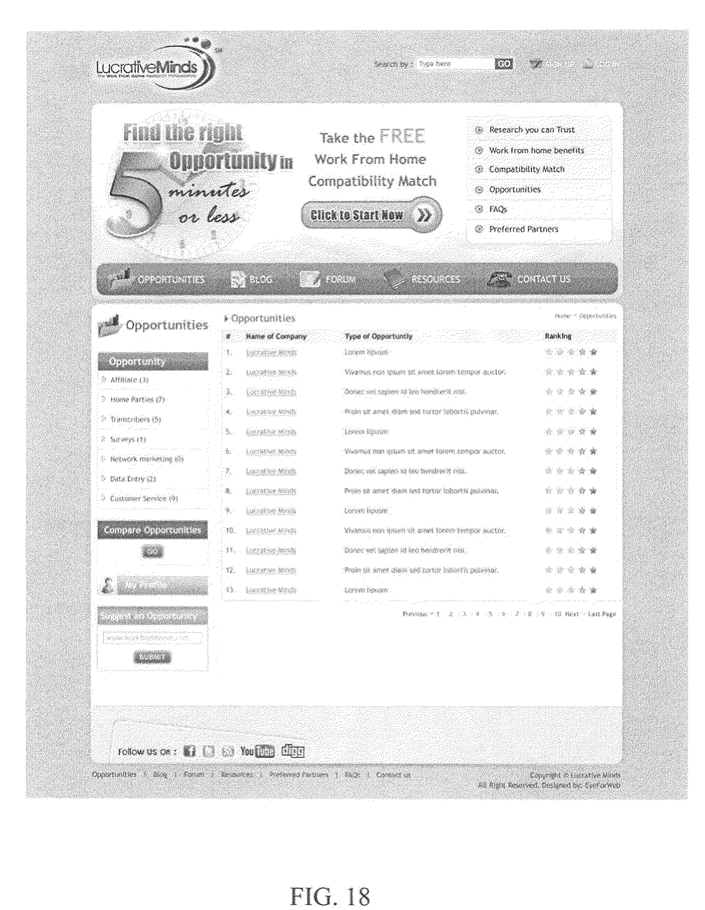

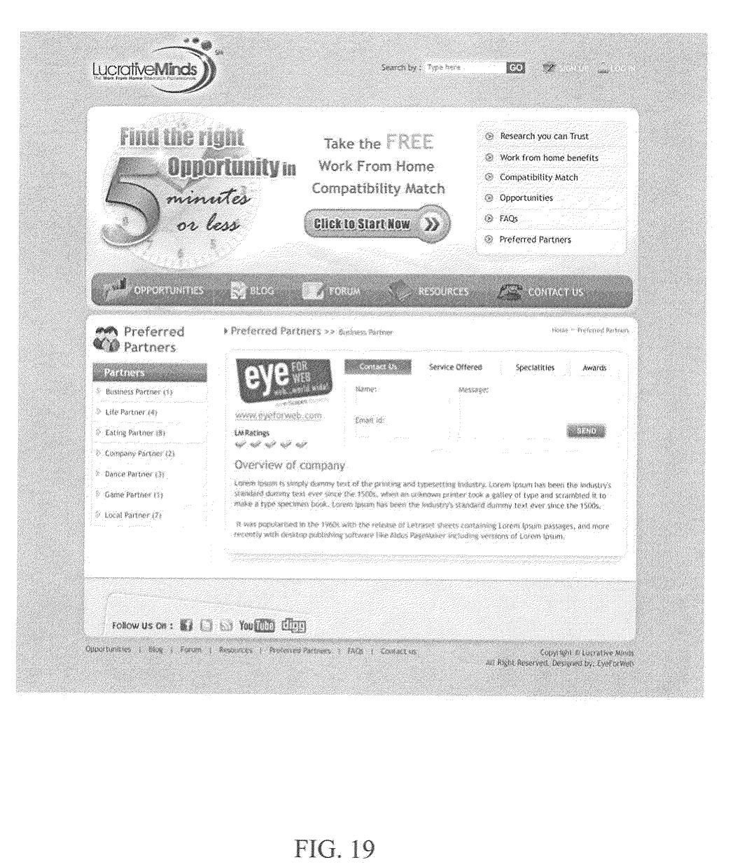

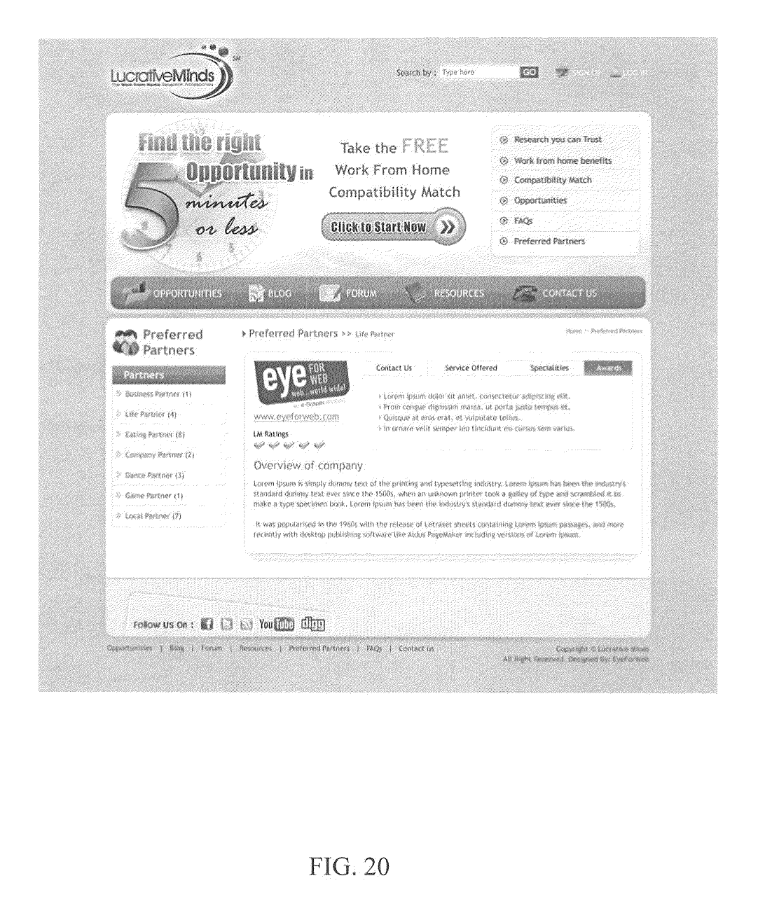

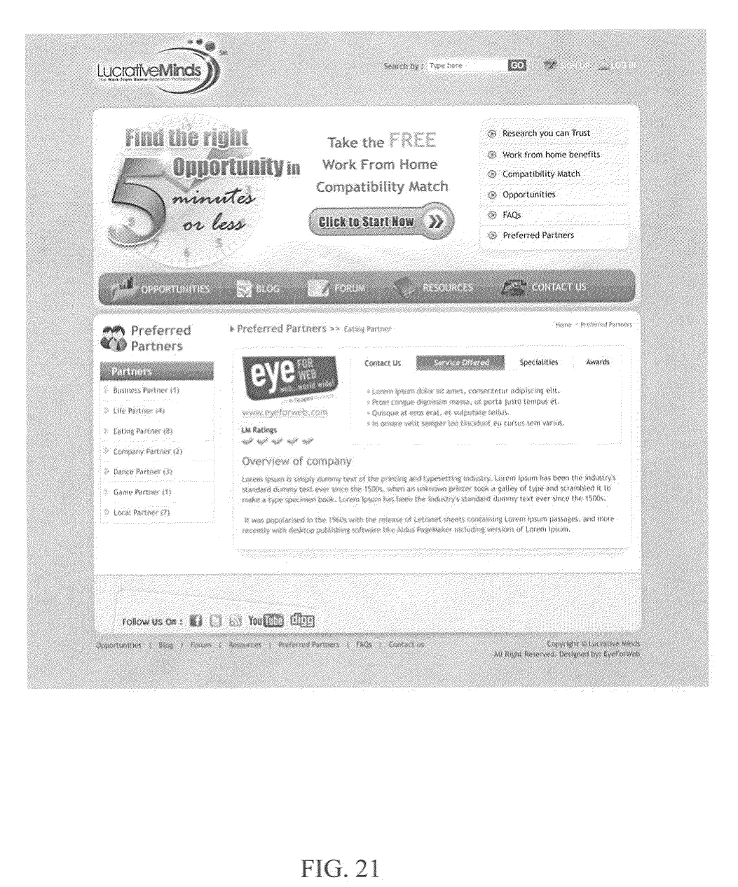

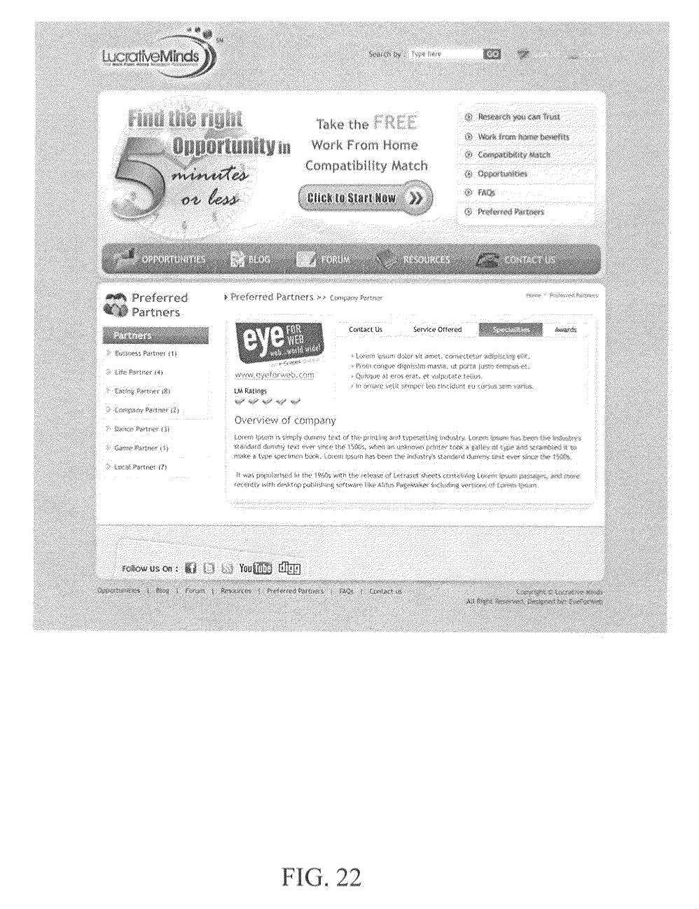

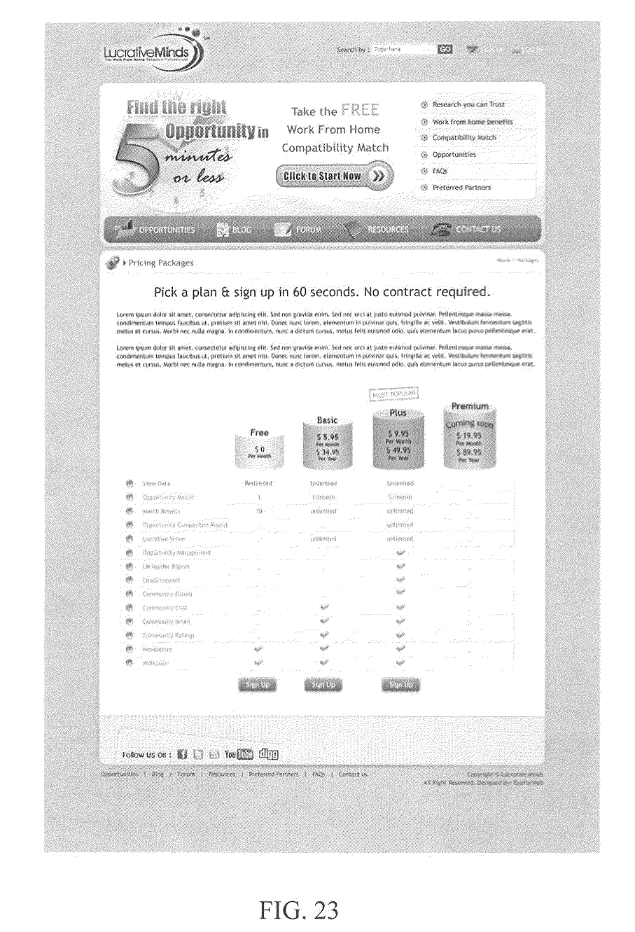

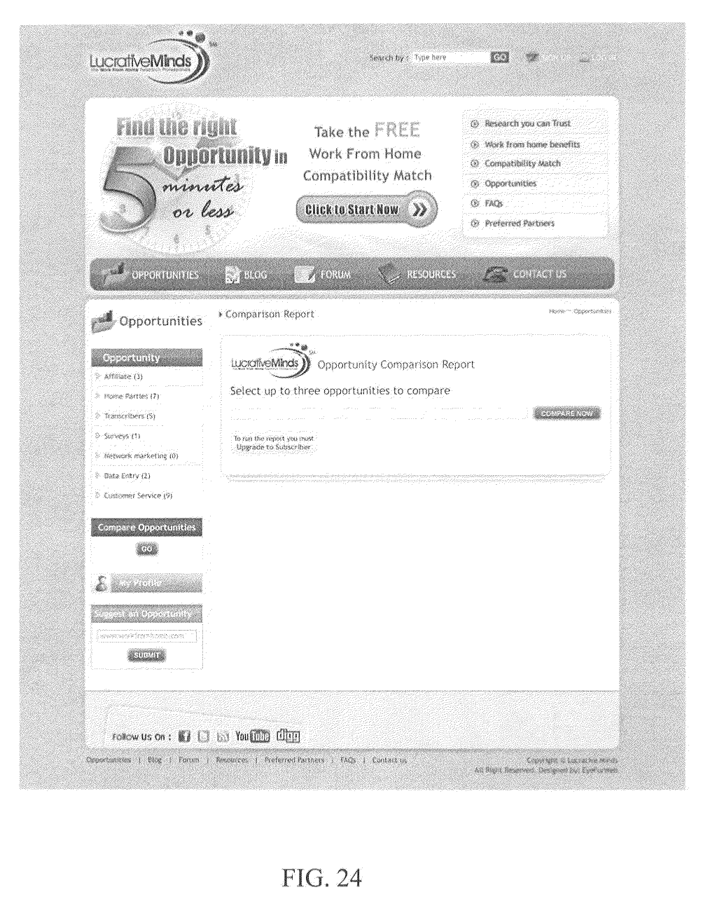

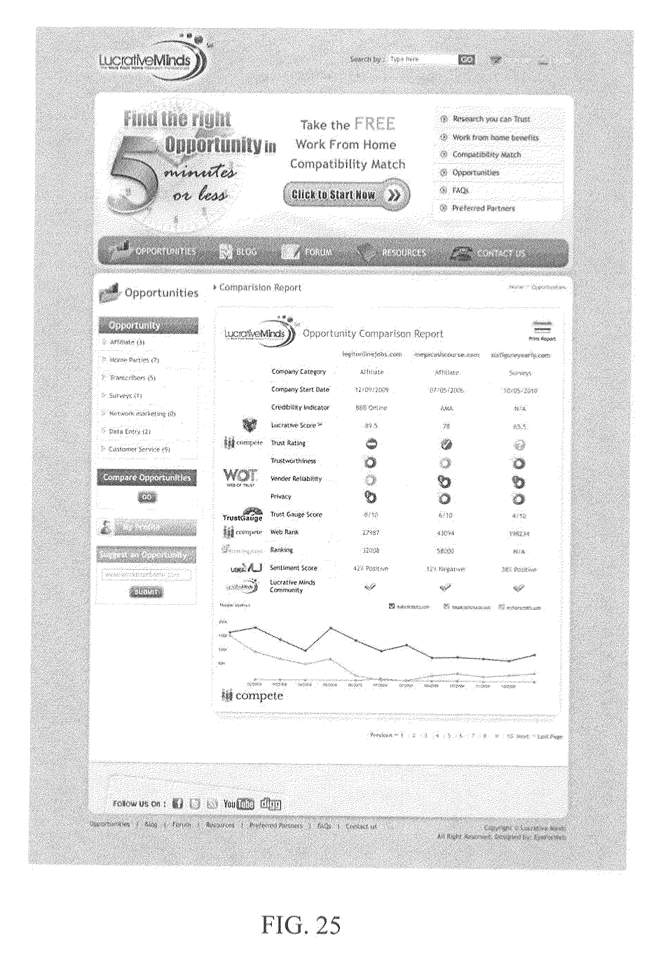

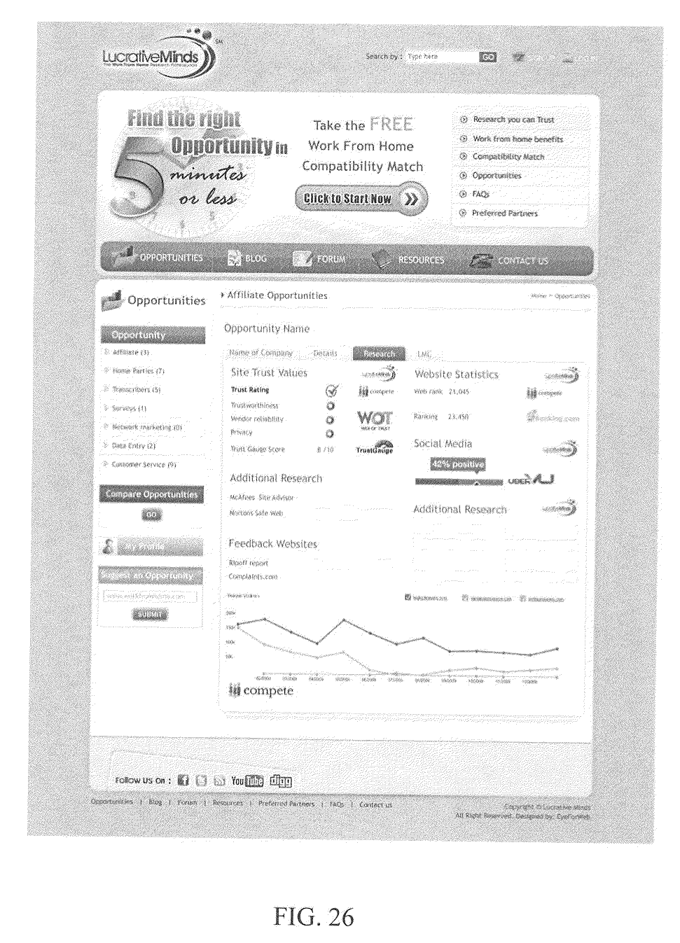

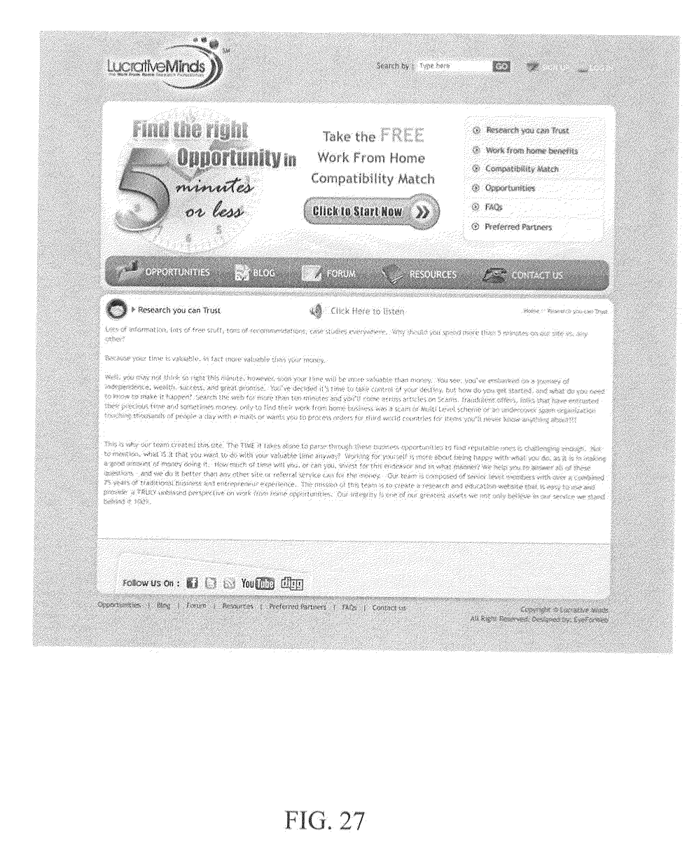

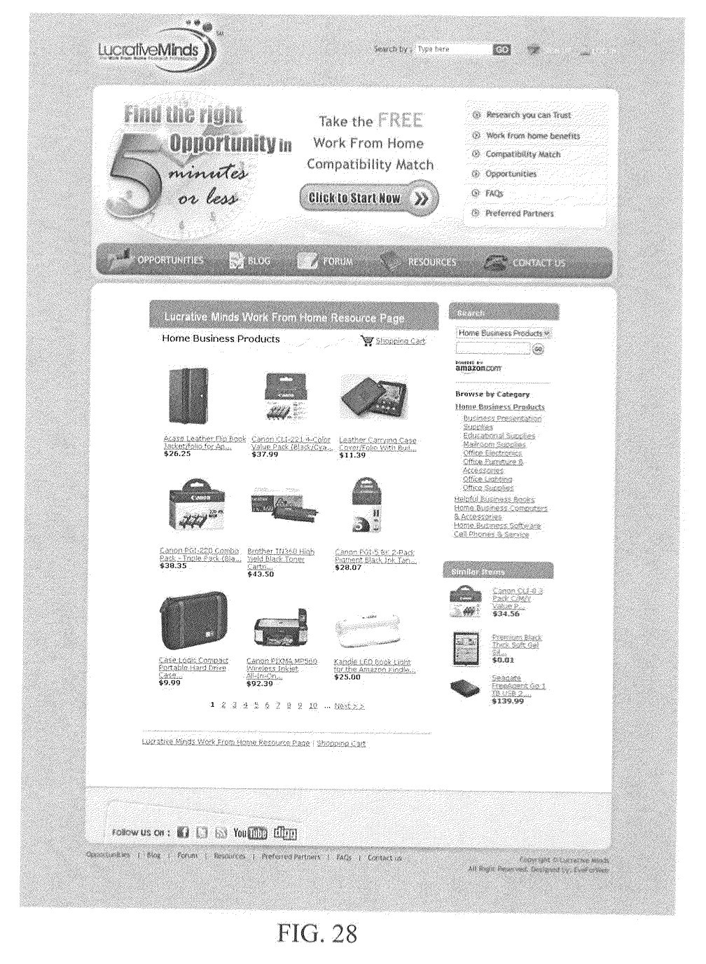

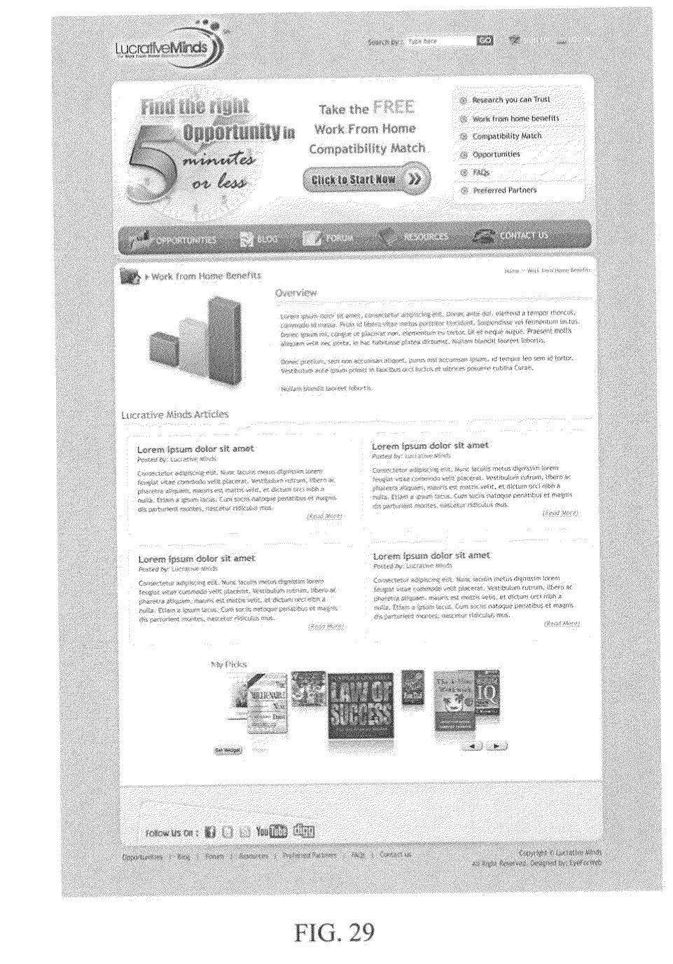

FIGS. 6 through 29 illustrate exemplary screen shots of exemplary GUIs that can be used to provide an opportunity-based service, as described herein. Each screen shot represents an exemplary graphic user interface (GUI) that can be utilized in performing one or more elements of the herein described systems and methods.

As illustrated in FIGS. 6 through 29, the systems and methods described herein can be provided to a user via one or more website pages. Alternatively, the systems and methods described herein can be provided to a user via one or more web applications, computer applications, mobile applications, social media (e.g. Facebook®), social media application, software integration, via third party integration such as one or more plug-ins, and/or the like.

Affiliate marketing can be utilized in conjunction or separate from the systems and methods described herein. User attributes 420_{1-N}, opportunity attributes 320_{1-N}, an opportunity 320, or a combination thereof, or other attributes described herein, can be leveraged and associated with one or more marketing campaigns (e.g., marketing elements), wherein said marketing campaigns can provide a user with the ability to review information associated with said campaign. For example, advertisements, banners, videos, audio, one or more of a click-through, single click, and/or a redirect can be utilized to provide a user with information relating to one or more marketing campaigns, or other information, wherein the marketing campaigns have been associated with at least one or more attributes as described herein (e.g., user attributes 420_{1-N}, opportunity attributes 320_{1-N}, opportunities, user, and/or the matched opportunity attributes 320_{1-N} and user attributes 420_{1-N}). In addition, an affiliate marketing campaign can be associated with one or more of the services described herein to provide an additional level of trustworthiness.

The systems and methods described herein (e.g., locating, compiling, analyzing and storing one or more attributes, score, and matching functionality) can employ a machine learning component, or various AI-based schemes, which can facilitate automating one or more features of the systems and methods described herein. For example, the systems and methods can employ various artificial intelligence based schemes for carrying out various aspects thereof. For example, with respect to modules, a process for determining what modules can be utilized for a given instance or implementation can be facilitated via an automatic classification system and process. Moreover, such classifiers can be used to build operational profiles of the system that start to detect system patterns, and learn various aspects of the systems and methods described herein (e.g. successful matches/attributes and unsuccessful matches/attributes). This information can then be fed back into the corresponding module and used as an updated module for a follow-on system. Such classification can employ a probabilistic and/or statistical-based analysis to prognose or infer an action that a user desires to be automatically performed. For example, a support vector machine (SVM) classifier can be employed. Other classification approaches include Bayesian networks, naive Bayes, decision trees, neural networks, fuzzy logic models, and probabilistic classification models providing different patterns of independence can be employed. Classification as used herein also is inclusive of statistical regression that is utilized to develop models of priority.

The module-based system can employ classifiers that are explicitly trained (e.g., via a generic training data) as well as implicitly trained (e.g., via observing user behavior, receiving extrinsic information) so that the classifiers are used to automatically determine according to a predetermined criteria one or more elements associated with the herein described system and methods. For example, with respect to SVM's that are well understood, SVM's are configured via a learning or training phase within a classifier constructor and feature selection module. A classifier is a function that maps an input attribute vector, x=(x1, x2, x3, x4, xn), to a confidence that the input belongs to a class—that is, f(x)=confidence(class). The classifier(s) can be used to automatically learn and perform a number of functions of the systems and methods described herein.

The forgoing detailed description provides exemplary embodiments of the invention and includes the best mode for practicing the invention. The description and illustration of embodiments are intended only to provide examples of the invention, and not to limit the scope of the invention, or its protection, in any manner.

What is claimed is:

1. A computer-implemented system for matching a user to one or more opportunities having one or more opportunity attributes, said system comprising the following computer executable components:
a storing component that stores said one or more opportunities having one or more opportunity attributes;
an access component that allows said user to access said system;
a questionnaire component that provides said user with one or more data forms requesting the submission of one or more user attributes;
a comparing component that compares one or more of the user attributes to one or more of said opportunity attributes and determining if one or more matching data points exist;
a matching component that matches one or more of said opportunity attributes with one or more of the user attributes based on one or more of the matching data points;
a scoring component that calculates a score for one or more of said opportunities based on one or more of the matching data points; and
a displaying component that displays the score and one or more of the matched opportunities to the user.

2. The system of claim 1, further comprising a filtering component that filters one or more of said opportunities based on the score calculated by the scoring component.

3. The system of claim 1, further comprising a researching component that allows said user to research one or more of said opportunity attributes and one or more of said opportunities.

4. The system of claim 1, further comprising a learning component that allows said user to access educational resources associated with one or more of said opportunities.

5. The system of claim 1, further comprising a marketing component that associates one or more marketing elements with one of the group consisting of one or more of the user attributes, one or more of the opportunity attributes, and the score provided by the scoring component.

6. The system of claim 5, wherein the marketing element comprises one of the group consisting of a click-through advertisement, a redirect link, and a single-click purchase.

7. The system of claim 1, wherein one or more of said opportunities comprise one of the group consisting of a job offering, real estate offering, and business offering.

8. A computer-implemented method of matching a user to one or more opportunities having one or more opportunity attributes, said method comprising the following computer-executable acts:
storing said one or more opportunities having one or more opportunity attributes;
affiliating one or more opportunity attributes with a point value, the point value within a range on a scale associated with the one or more opportunity attributes, the point value based on a factor associated with the scale;
aggregating the point value associated with one or more of the opportunity attributes;
affiliating one or more opportunities with a point value based on the aggregated point value;
associating one or more opportunities with a percentage based on the aggregated point value and the scale; and
providing said user with the percentage.

9. The method of claim 8, wherein the step of providing said user with the percentage further comprises proving the user with one or more of said opportunity attributes and the affiliated point value.

10. The method of claim 8, further comprising the step of requesting user authentication prior to the step of affiliating one or more opportunity attributes with a point value.

11. The method of claim 8, wherein one or more of said opportunities comprise one of the group consisting of a job offering, real estate offering, and business offering.

12. The method of claim 11, wherein one or more of said opportunity attributes comprise one of the group consisting of a company information, community rating, competitor information, trust rating, trustworthiness, vender reliability, and user feedback.

13. The method of claim 8, wherein the step of associating one or more opportunities with a percentage based on the aggregated point value and the scale is performed autonomously.

14. The method of claim 8, further comprising the step of affiliating one or more marketing elements with one or more of the opportunity attributes.

15. The method of claim 14, wherein one or more of the marketing elements comprise one of the group consisting of a click-through advertisement, a redirect link, and a single-click purchase.

16. The method of claim 8, further comprising the step of affiliating one or more marketing elements with one or more of the point values associated with one or more opportunity attributes.

17. A computer-implemented method of matching to a user to one or more work from home opportunities having one or more work from home opportunity attributes, said method comprising the following computer-executable acts:
storing said one or more work from home opportunities having one or more work from home opportunity attributes;
requesting information from said user, the information relating to at least one of the group consisting of work experience, current employment status, availability, and educational background;
saving the information requested from said user as user attributes;
comparing one or more of said work from home opportunity attributes with one or more of the user attributes;
determining if one or more matching data points exists;
matching one or more of the work from home opportunity attributes with one or more of the user attributes based on one or more of the matching data points;
scoring the compatibility of one or more of said work from home opportunities and said user based on one or more of the matching data points;
providing said user with the score of one or more of the matched work from home opportunities; and
affiliating one or more marketing elements with one or more of the user attributes.

18. The method of claim 17, wherein one or more of the marketing elements comprise one of the group consisting of a click-through advertisement, a redirect link, and a single-click purchase.

19. The method of claim 17, further comprising the step of affiliating one or more marketing elements with one or more of the work from home opportunity attributes.

20. The method of claim 17, further comprising the step of affiliating one or more marketing elements with one or more of the matched work from home opportunity attributes.
